(19) United States
(12) Patent Application Publication
(10) Pub. No.: US 2026/0136269 A1
(43) Pub. Date: May 14, 2026

(54) COMMUNICATION APPARATUS, BASE STATION, AND COMMUNICATION METHOD

(71) Applicant: DENSO CORPORATION, Kariya-city (JP)

(72) Inventor: Tomoyuki YAMAMOTO, Kariya-city (JP)

(21) Appl. No.: 19/442,745

(22) Filed: Jan. 7, 2026

Related U.S. Application Data
(63) Continuation of application No. PCT/JP2024/023881, filed on Jul. 2, 2024.

(30) Foreign Application Priority Data
Jul. 12, 2023 (JP) 2023-114766

(51) Int. Cl. H04W 40/24; H04L 45/00

(52) U.S. Cl. CPC H04W 40/248; H04L 45/22

(57) ABSTRACT

A communication apparatus comprises: a controller configured to execute a procedure for reporting path information indicating a path of the communication apparatus to a base station; and a transmitter configured to transmit information regarding a priority of the path to the base station.

### CROSS-REFERENCE TO RELATED APPLICATION

The present application is a continuation application of international Patent Application No. PCT/JP2024/023881, filed on Jul. 2, 2024, which designated the U.S., and claims the benefit of priority of Japanese Patent Application No. 2023-114766, filed on Jul. 12, 2023, the entire contents of which are incorporated herein by reference.

### TECHNICAL FIELD

The present disclosure relates to a communication apparatus, a base station, and a communication method used in a mobile communication system.

### BACKGROUND ART

Release 17 of the technical specification (TS) for the 4th generation system (4G/LTE: Long Term Evolution) defined by 3GPP (registered trademark; the same applies hereinafter) (3rd Generation Partnership Project), which is a mobile communication system standardization project, defines that when a communication apparatus has available path information (specifically, flight path information), the communication apparatus includes availability information (specifically, flightPathInfoAvailable) in an RRC message (for example, RRC connection reconfiguration complete message) transmitted in response to a radio resource control (RRC) message from a base station. The base station that has received the availability information can acquire path information from the communication apparatus by requesting the path information from the communication apparatus.

In recent years, regarding NR (New Radio), an operation in a case where path information is updated in a communication apparatus after the path information is reported from the communication apparatus to a base station has been discussed. Currently, it has been agreed that a network can configure a communication apparatus to trigger path information update notification (flightpath update notification) based on a configured distance difference (for example, a spatial difference), or a time difference that is configured if it is configured to report a timestamp (see, for example, Non Patent Literature 1). The base station that has received the update notification can acquire the updated path information from the communication apparatus by requesting the path information from the communication apparatus. As a result, the network can appropriately execute communication control (for example, handover control, beamforming control, and the like) with the communication apparatus based on the updated path information.

### CITATION LIST

### Non Patent Literature

Non Patent Literature 1: 3GPP TSG-RAN WG 2 Meeting #122, R 2-2306543, “Report from Session on NES, UAV, Rel-15-17 UP, Rel-17 Small Data, IIoT/URLLC, and RACH partitioning”

### SUMMARY OF INVENTION

A communication apparatus according to a first aspect comprises: a controller configured to execute a procedure for reporting path information indicating a path of the communication apparatus to a base station; and a transmitter configured to transmit information regarding a priority of the path to the base station.

A base station according to a second aspect comprises: a receiver configured to receive information regarding a priority of a path from a communication apparatus in a procedure for reporting path information indicating a path of the communication apparatus to the base station.

A communication method according to a third aspect is a communication method executed by a communication apparatus. The communication method comprises: a step of executing a procedure for reporting path information indicating a path of the communication apparatus to a base station. The step includes a step of transmitting information regarding a priority of the path to the base station.

### BRIEF DESCRIPTION OF DRAWINGS

Objects, features, advantages, and the like of the present disclosure will become more apparent from the following detailed description with reference to the accompanying drawings.

FIG. 1 is a diagram illustrating a configuration of a mobile communication system according to an embodiment.

FIG. 2 is a diagram illustrating a configuration example of a protocol stack according to the embodiment.

FIG. 3 is a sequence diagram for describing an assumed scenario.

FIG. 4 is a diagram illustrating a configuration of a user equipment (UE) according to the embodiment.

FIG. 5 is a diagram illustrating a configuration of a base station according to the embodiment.

FIG. 6 is a sequence diagram for describing a first operation example according to the embodiment.

FIG. 7 is a diagram (part 1) for describing an example of an information element of the first operation example according to the embodiment.

FIG. 8 is a diagram (part 2) for describing an example of an information element of the first operation example according to the embodiment.

FIG. 9 is a sequence diagram for describing a second operation example according to the embodiment.

FIG. 10 is a diagram (part 1) for describing an example of an information element of the second operation example according to the embodiment.

FIG. 11 is a diagram (part 2) for describing an example of an information element of the second operation example according to the embodiment.

### DESCRIPTION OF EMBODIMENTS

A mobile communication system according to an embodiment will be described with reference to the drawings. In the description of the drawings, the same or similar parts are denoted by the same or similar reference numerals.

For example, a situation is assumed in which the communication apparatus has to arrive at a destination in a hurry due to an occurrence of a sudden illness, an occurrence of a disaster, or the like.

Here, for example, in a case where path information is acquired from a large number of communication apparatuses, the network may not be able to appropriately execute communication control based on the path information for a communication apparatus that needs to arrive at a destination in a hurry due to network congestion or the like. As a result, the arrival of the communication apparatus at the destination is delayed, and there is a concern that the situation will deteriorate.

Therefore, an object of the present disclosure is to provide a communication apparatus, a base station, and a communication method that easily execute communication control based on path information for a communication apparatus for which communication control based on path information is desired.

### System Configuration

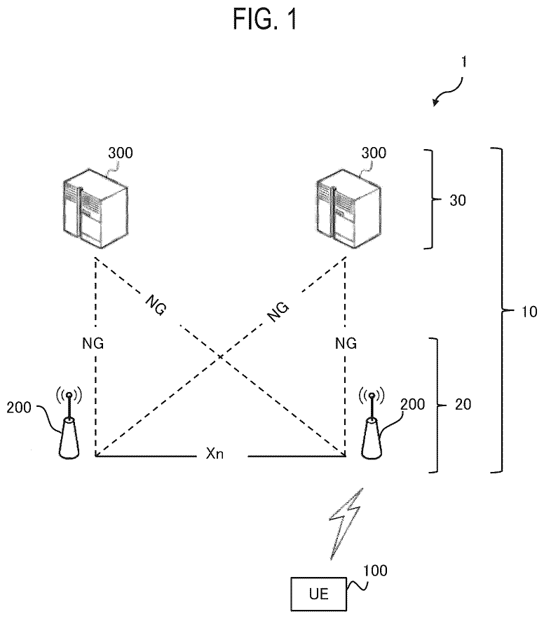

First, a configuration of a mobile communication system 1 according to the present embodiment will be described with reference to FIG. 1. The mobile communication system 1 is, for example, a system conforming to a technical specification (Technical Specification: TS) of 3GPP. Hereinafter, as the mobile communication system 1, a 5th generation system (5th Generation System: 5G system) of the 3GPP standard, that is, a mobile communication system based on NR (NR (New Radio) Radio Access) will be described as an example.

The mobile communication system 1 includes a network 10 and a user equipment (User Equipment: UE) 100 that communicates with the network 10. The network 10 includes an NG-RAN (Next Generation Radio Access Network) 20, which is a 5G radio access network, and a 5GC (5G Core Network) 30, which is a 5G core network.

The UE 100 is an example of a communication apparatus. The UE 100 may be a mobile radio communication apparatus. The UE 100 may be a communication apparatus that communicates via a base station 200. The UE 100 may be an apparatus used by a user. The UE 100 may be a user equipment defined in the 3GPP technical specification. The UE 100 is, for example, a mobile apparatus such as a mobile phone terminal such as a smartphone, a tablet terminal, a laptop PC, a communication module, or a communication card. The UE 100 may be a vehicle (for example, a car, a train, or the like) or an apparatus provided in the vehicle. The UE 100 may be a transport body other than a vehicle (for example, a ship, an airplane, or the like) or an apparatus provided in the transport body. The UE 100 may be a sensor or an apparatus provided in the sensor. Note that the UE 100 may be referred to by another name such as a terminal, a terminal apparatus, a mobile station, a mobile terminal, a mobile apparatus, a mobile unit, a subscriber station, a subscriber terminal, a subscriber apparatus, a subscriber unit, a wireless station, a wireless terminal, a wireless apparatus, a wireless unit, a remote station, a remote terminal, a remote apparatus, or a remote unit. In addition, the UE 100 is an example of a terminal, and the terminal may include a factory apparatus or the like.

The UE 100 (that is, the communication apparatus) may be an unmanned aerial vehicle (UAV) or a communication module mounted on the UAV. Note that the present embodiment may be applied not only to a UAV but also to any vehicle such as a manned and unmanned vehicle including a car and an autonomous vehicle/semi-autonomous vehicle, and a ship and an autonomous ship/semi-autonomous ship. That is, the present embodiment can be applied to any vehicle including the above-described vehicles.

The NG-RAN 20 includes a plurality of base stations 200. Each base station 200 manages at least one cell. A cell constitutes a minimum unit of a communication area. One cell belongs to one frequency (carrier frequency). The term “cell” may represent a radio communication resource or a communication target of the UE 100. Each base station 200 can perform radio communication with a UE 100 that exists in its own cell. The base station 200 communicates with the UE 100 using a protocol stack of a RAN. Details of the protocol stack will be described later. Further, the base station 200 is connected to another base station 200 (which may be referred to as a neighboring base station) via an Xn interface. The base station 200 communicates with a neighboring base station via the Xn interface. Furthermore, the base station 200 provides NR user plane and control plane protocol termination toward the UE 100 and is connected to the 5GC 30 via an NG interface. Such a base station 200 of NR may be referred to as a gNodeB (gNB). Note that an operation of the base station 200 may be replaced with an operation of the network 10.

The 5GC 30 includes a core network apparatus 300. The core network apparatus 300 includes, for example, an AMF (Access and Mobility Management Function) and/or a UPF (User Plane Function). The AMF performs mobility management of the UE 100. The UPF provides a function specialized for U-plane processing. The AMF and the UPF are connected to the base station 200 via the NG interface.

### Configuration Example of Protocol Stack

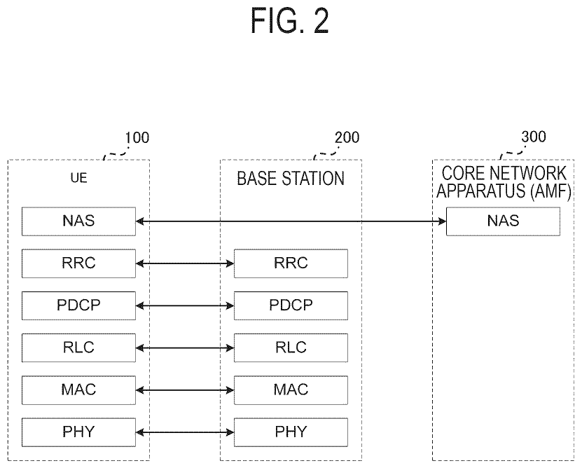

Next, a configuration example of a protocol stack according to the present embodiment will be described with reference to FIG. 2.

A protocol in a radio section between the UE 100 and the base station 200 includes a physical (PHY) layer, a MAC (Medium Access Control) layer, an RLC (Radio Link Control) layer, a PDCP (Packet Data Convergence Protocol) layer, and an RRC (Radio Resource Control) layer.

The PHY layer performs encoding/decoding, modulation/demodulation, antenna mapping/demapping, and resource mapping/demapping. Data and control information are transmitted between the PHY layer of the UE 100 and the PHY layer of the base station 200 via a physical channel.

The MAC layer performs priority control of data, retransmission processing by hybrid ARQ (HARQ), a random access procedure, and the like. Data and control information are transmitted between the MAC layer of the UE 100 and the MAC layer of the base station 200 via a transport channel. The MAC layer of the base station 200 includes a scheduler. The scheduler determines uplink and downlink transport formats (a transport block size, a modulation and coding scheme (MCS)) and a resource to be allocated to the UE 100.

The RLC layer transmits data to an RLC layer on a reception side using functions of the MAC layer and the PHY layer. Data and control information are transmitted between the RLC layer of the UE 100 and the RLC layer of the base station 200 via a logical channel.

The PDCP layer performs header compression/decompression and encryption/decryption.

An SDAP (Service Data Adaptation Protocol) layer may be provided as a layer higher than the PDCP layer. The SDAP (Service Data Adaptation Protocol) layer performs mapping between an IP flow, which is a unit for a core network to perform QoS (Quality of Service) control, and a radio bearer, which is a unit for an AS (Access Stratum) to perform QoS control.

The RRC layer controls a logical channel, a transport channel, and a physical channel in accordance with establishment, reestablishment, and release of a radio bearer. RRC signaling for various configurations is transmitted between an RRC layer of the UE 100 and an RRC layer of the base station 200. When there is an RRC connection between the RRC layer of the UE 100 and the RRC layer of the base station 200, the UE 100 is in an RRC connected state. When there is no RRC connection between the RRC layer of the UE 100 and the RRC layer of the base station 200, the UE 100 is in an RRC idle state. When the RRC connection between the RRC layer of the UE 100 and the RRC layer of the base station 200 is suspended, the UE 100 is in an RRC inactive state.

An NAS layer located higher than the RRC layer in the UE 100 performs session management and mobility management of the UE 100. NAS signaling is transmitted between the NAS layer of the UE 100 and an NAS layer of the core network apparatus 300.

Note that the UE 100 has an application layer and the like in addition to the protocol of the radio interface.

### Radio Frame Configuration

In the 5G system, downlink transmission and uplink transmission are configured within a radio frame having a duration of 10 ms. For example, a radio frame is configured by 10 subframes. For example, one subframe may be 1 ms. Further, one subframe may be configured by one or more slots. For example, the number of symbols that constitute one slot is 14 with a normal CP (Cyclic Prefix) and 12 with an extended CP. Further, the number of slots that constitute one subframe changes according to a configured subcarrier spacing. For example, for the normal CP, when the subcarrier spacing is configured as 15 kHz, the number of slots per subframe is 1 (that is, 14 symbols), when the subcarrier spacing is configured as 30 kHz, the number of slots per subframe is 2 (that is, 28 symbols), when the subcarrier spacing is configured as 60 kHz, the number of slots per subframe is 4 (that is, 56 symbols), and when the subcarrier spacing is configured as 120 kHz, the number of slots per subframe is 8 (that is, 128 symbols). Further, for the extended CP, when the subcarrier spacing is configured as 60 kHz, the number of slots per subframe is 4 (that is, 48 symbols). That is, the number of slots that constitute one subframe is determined based on the subcarrier spacing configured by the base station 200. Further, the number of symbols that constitute one subframe is determined based on the subcarrier spacing configured by the base station 200. That is, the number of symbols that constitute a 1 ms subframe is determined based on the subcarrier spacing configured by the base station 200, and the length (length in the time direction) of each symbol changes.

### Assumed Scenario

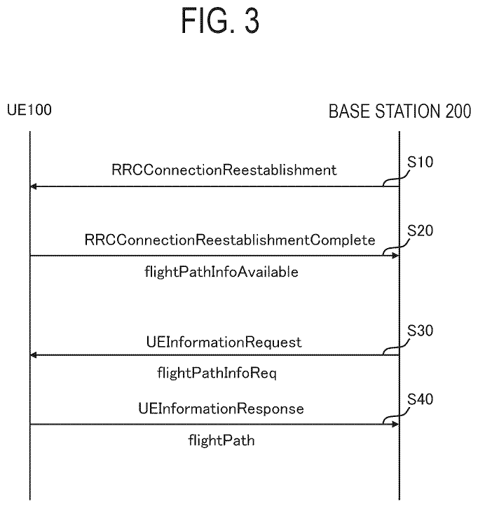

An assumed scenario in the mobile communication system 1 according to the embodiment will be described with reference to FIG. 3. Release 17 of 3GPP, which is a mobile communication system standardization project, defines that when the UE 100 has flight path information, it includes availability information (specifically, flightPathInfoAvailable) in an RRC message transmitted as a response to an RRC message from the base station 200.

As illustrated in FIG. 3, in step S10, the base station 200 transmits, for example, an RRC Connection Reestablishment (RRCConnectionReestablishment) message to the UE 100. The UE 100 receives the RRC Connection Reestablishment message from the base station 200.

In step S20, after the reestablishment of the RRC connection is successfully completed, the UE 100 transmits an RRC Connection Reestablishment Complete (RRCConnectionReestablishmentComplete) message to the base station 200 as a response to the RRC Connection Reestablishment message. The base station 200 receives the RRC Connection Reestablishment Complete message. If the UE 100 has available flight path information, it can include the availability information in the RRC Connection Reestablishment Complete message.

In step S30, the base station 200 transmits a UE Information Request (UEInformationRequest) message including a flight path information request (flightPathInfoReq) to the UE 100. The UE 100 receives the UE Information Request message from the base station 200.

In step S40, based on the flight path information request, the UE 100 transmits a UE Information Response (UEInformationResponse) message including the flight path information (flightPath) to the base station 200. The base station 200 receives the UE Information Response message from the UE 100. In this way, the base station 200 that has received the availability information can acquire the flight path information from the UE 100 by requesting it. As a result, the network 10 can appropriately execute communication control (for example, handover control, beamforming control, and the like) with the communication apparatus based on the updated flight path information.

In step S40, based on the flight path information request, the UE 100 transmits a UE Information Response (UEInformationResponse) message including the flight path information (flightPath) to the base station 200. The base station 200 receives the UE Information Response message from the UE 100. In this way, the base station 200 that has received the availability information can acquire the flight path information from the UE 100 by requesting it. As a result, the network 10 can appropriately execute communication control (for example, handover control, beamforming control, and the like) with the UE 100 based on the updated path information.

For example, a situation is assumed in which the UE 100 has to arrive at a destination in a hurry due to an occurrence of a sudden illness, an occurrence of a disaster, or the like. Here, for example, in a case where path information is acquired from a large number of UEs 100, the network 10 may not be able to appropriately execute communication control based on the path information, on a UE 100 that needs to arrive at a destination in a hurry due to network congestion or the like. As a result, the arrival of the UE 100 at the destination is delayed, and there is a concern that the situation will deteriorate. In an embodiment to be described below, an operation for facilitating execution of communication control based on path information, on a UE 100 for which communication control based on path information is desired will be described.

### Configuration of UE

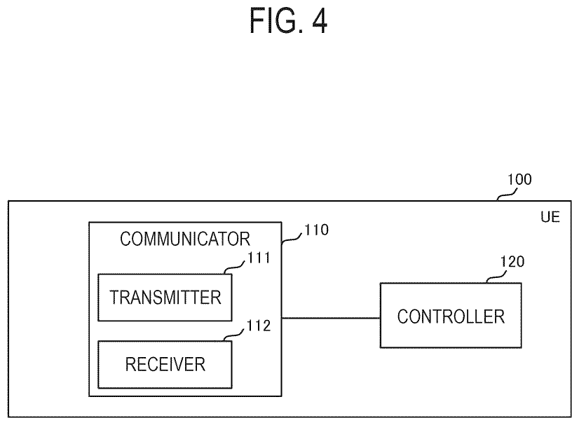

A configuration of the UE 100 according to the embodiment will be described with reference to FIG. 4. The UE 100 includes a communicator 110 and a controller 120.

The communicator 110 performs radio communication with the base station 200 by transmitting and receiving a radio signal to and from the base station 200. The communicator 110 has at least one transmitter 111 and at least one receiver 112. The transmitter 111 and the receiver 112 may be configured to include a plurality of antennas and RF circuits. The antennas convert signals into radio waves and radiate the radio waves into space. The antennas also receive radio waves in space and convert the radio waves into signals. The RF circuits perform analog processing of signals transmitted and received via the antennas. The RF circuits may include a high-frequency filter, an amplifier, a modulator, a low-pass filter, and the like.

The controller 120 performs various types of control in the UE 100. The controller 120 controls communication with the base station 200 via the communicator 110. The operations of the UE 100 described above and below may be operations under the control of the controller 120. The controller 120 may include at least one processor capable of executing a program and a memory that stores the program. The processor may execute the program to perform the operations of the controller 120. The controller 120 may include a digital signal processor that performs digital processing of signals transmitted and received via the antennas and the RF circuits. The digital processing includes processing of the RAN protocol stack. The memory stores a program executed by the processor, parameters related to the program, and data related to the program. The memory may include at least one of a ROM (Read Only Memory), an EPROM (Erasable Programmable Read Only Memory), an EEPROM (Electrically Erasable Programmable Read Only Memory), a RAM (Random Access Memory), and a flash memory. All or a part of the memory may be included in the processor.

In the UE 100 configured as described above, the controller 120 executes a path report procedure for reporting the path information regarding the planned path of the UE 100 to the base station 200. The transmitter 111 transmits priority information regarding a priority of the path to the base station 200 in the path report procedure. As a result, the base station 200 can grasp the priority of the path. The base station 200 can easily execute the communication control based on the path information on a UE 100 having a high priority of the path, that is, a UE 100 for which the communication control based on the path information is desired. As a result, the UE 100 can arrive at the destination in a favorable communication environment. Furthermore, for example, in a case where it is desired to preferentially secure a favorable communication environment such as when a flying UE 100 performs emergency landing due to a failure of equipment or a sudden illness of an occupant, the network 10 can preferentially perform communication control such as beam control based on the priority information. As a result, it is possible to contribute to securing a favorable communication environment in an emergency.

### Configuration of Base Station

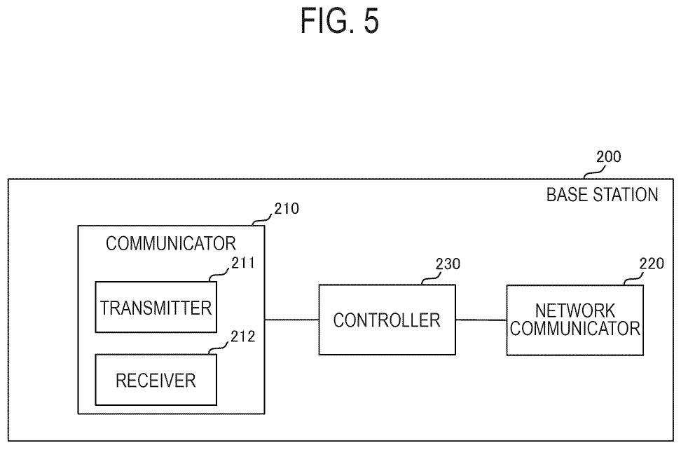

A configuration of the base station 200 according to the embodiment will be described with reference to FIG. 5. The base station 200 includes a communicator 210, a network communicator 220, and a controller 230.

The communicator 210, for example, receives a radio signal from the UE 100 and transmits a radio signal to the UE 100. The communicator 210 has at least one transmitter 211 and at least one receiver 212. The transmitter 211 and the receiver 212 may be configured to include RF circuits. The RF circuits perform analog processing of signals transmitted and received via antennas. The RF circuits may include a high-frequency filter, an amplifier, a modulator, a low-pass filter, and the like.

The network communicator 220 transmits and receives signals to and from the network. The network communicator 220, for example, receives a signal from a neighboring base station connected via an Xn interface, which is an interface between base stations, and transmits a signal to the neighboring base station. The network communicator 220 also, for example, receives a signal from the core network apparatus 300 connected via an NG interface and transmits a signal to the core network apparatus 300.

The controller 230 performs various types of control in the base station 200. The controller 230, for example, controls communication with the UE 100 via the communicator 210. The controller 230 also, for example, controls communication with nodes (for example, a neighboring base station, the core network apparatus 300) via the network communicator 220. The operations of the base station 200 described above and below may be operations under the control of the controller 230. The controller 230 may include at least one processor capable of executing a program and a memory that stores the program. The processor may execute the program to perform the operations of the controller 230. The controller 230 may include a digital signal processor that performs digital processing of signals transmitted and received via the antennas and the RF circuits. The digital processing includes processing of the RAN protocol stack. The memory stores a program executed by the processor, parameters related to the program, and data related to the program. All or a part of the memory may be included in the processor.

In the base station 200 configured as described above, the receiver 212 receives the priority information regarding the priority of the path from the UE 100 in the path report procedure, so that the base station 200 can grasp the priority of the path. The base station 200 can easily execute the communication control based on the path information on a UE 100 having a high priority of the path, that is, a UE 100 for which the communication control based on the path information is desired. As a result, the UE 100 can arrive at the destination in a favorable communication environment. Furthermore, for example, in a case where it is desired to preferentially secure a favorable communication environment such as when a flying UE 100 performs emergency landing due to a failure of equipment or a sudden illness of an occupant, the network 10 can preferentially perform communication control such as beam control based on the priority information. As a result, it is possible to contribute to securing a favorable communication environment in an emergency.

### First Operation Example

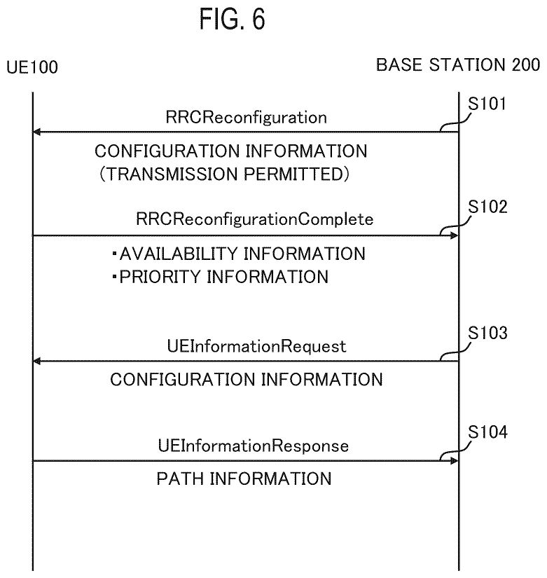

A first operation example of the mobile communication system 1 will be described with reference to FIGS. 6 to 8. The sequence of the present operation example may be a procedure (hereinafter, referred to as a path report procedure as appropriate) for reporting the path information to the base station 200. Alternatively, the processes in and after step S102 may be a path report procedure. The controller 120 of the UE 100 controls the operation of the UE 100 in the path report procedure. Similarly, the controller 230 of the base station 200 controls the operation of the base station 200 in the path report procedure. Note that hereinafter, the operation of the base station 200 may be the operation of the network 10.

### Step S101

The transmitter 211 of the base station 200 transmits, for example, a message including configuration information to the UE 100. The transmitter 211 may transmit, for example, an RRC Reconfiguration (RRCReconfiguration) message to the UE 100 as the message including configuration information. Note that the message may be at least one of an RRC Setup (RRCSetup) message, an RRC Reestablishment (RRCReestablishment) message, and an RRC Resume (RRCResume) message. Note that the message transmitted in S101 may be, for example, a message for causing the UE 100 to transmit a message including availability information to be described below.

The receiver 112 of the UE 100 receives the message from the base station 200. The receiver 112 may receive, for example, at least one of an RRC reconfiguration message, an RRC setup message, an RRC reestablishment message, and an RRC resume message.

The configuration information may include, for example, predetermined configuration information regarding update control for notifying the base station 200 of a path information update. The predetermined configuration information may include, for example, a threshold for determining whether or not to notify of the path information update. The threshold may be information for triggering the notification of the path information update. The threshold may be information for configuring a distance difference (for example, a spatial difference) and/or a time difference in the UE 100. The threshold may include a distance threshold for configuring the distance difference in the UE 100 and a time threshold for configuring the time difference in the UE 100.

The distance threshold may be used, for example, for comparison with a calculated distance difference calculated based on a new path of the UE 100. The new path may be a path different from a reported path. The new path is a path in which at least a part is changed from the reported path. The new path may be a path newly acquired by the UE 100 (the controller 120) after the report of the path information. The distance threshold may be used, for example, for comparison with a distance difference based on a point on the changed path. The distance threshold may be used, for example, for comparison with (a) a distance from a point on the reported path to a point on the changed path, (b) a distance from a destination of the reported path to a destination of the changed path, or (c) a distance from a measurement location (for example, a latest measurement location (current location)) of the UE 100 to a point closest to the measurement location among points on the path reported by the UE 100. The distance threshold may be used for comparison with a calculated distance difference calculated based on the location of the UE 100.

The time threshold may be used, for example, for comparison with a calculated time difference calculated based on a planned time of a new path of the UE 100. The time threshold may be used, for example, for comparison with a time difference based on a planned arrival time at a point on the changed path. The time threshold may be used, for example, for comparison with (a) a time difference between a planned arrival time at each point on the reported path (that is, the time of the reported timestamp) and a planned arrival time at each point on the changed path, (b) a time difference between a planned arrival time at a destination of the reported path and a planned arrival time at a destination of the changed path, or (c) a time difference between a planned arrival time at a point on the path reported by the UE 100 and a time at which the UE 100 arrives at the point. The time threshold may be used for comparison with a calculated time difference calculated based on the measurement time of the UE 100.

The configuration information may indicate that transmission of priority information to be described below has been permitted. The configuration information may include, for example, information (hereinafter, referred to as transmission permission/non-permission information as appropriate) indicating whether or not transmission of the priority information has been permitted. When permitting the transmission of the priority information, the controller 230 of the base station 200 may include, in the configuration information, transmission permission/non-permission information indicating that the transmission of the priority information has been permitted. As a result, the configuration information may indicate that the transmission of the priority information has been permitted. On the other hand, when not permitting transmission of the priority information, the controller 230 may include, in the configuration information, transmission permission/non-permission information indicating that transmission of the priority information has not been permitted.

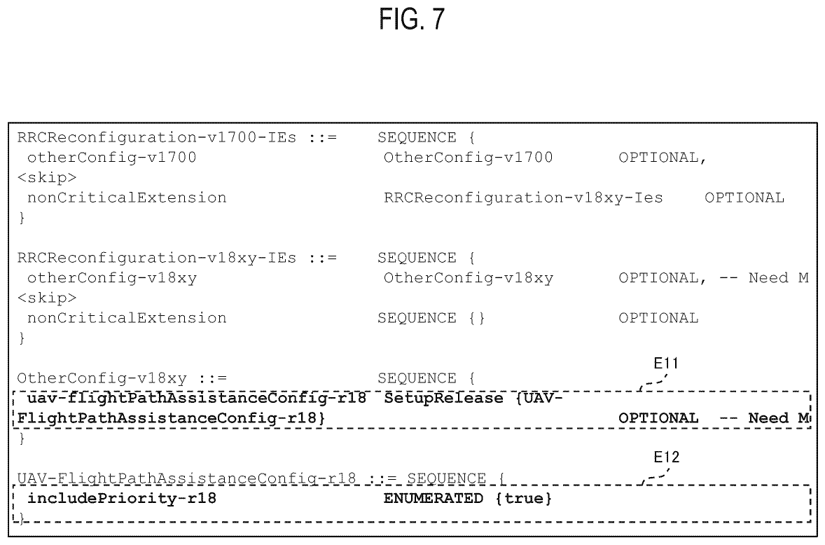

The transmission permission/non-permission information may be included in predetermined configuration information (for example, uav-flightPathAssistanceConfig in E11 of FIG. 7). As illustrated in E12 of FIG. 7, when permitting the transmission of the priority information, the controller 230 may set information indicating that the transmission of the priority information has been permitted (for example, “true” in E12 of FIG. 7) in a predetermined field in which transmission permission/non-permission information can be set. On the other hand, when not permitting the transmission of the priority information, the controller 230 may set an empty value (or a null value) in the predetermined field. Alternatively, the controller 230 may not include the predetermined field in the configuration information (or predetermined configuration information).

Alternatively, when permitting the transmission of the priority information, the controller 230 may include information indicating that the transmission of the priority information has been permitted in the configuration information. On the other hand, when not permitting the transmission of the priority information, the controller 230 may not include the information indicating that the transmission of the priority information has been permitted in the configuration information.

Alternatively, when permitting the transmission of the priority information, the controller 230 may not include the information indicating that the transmission of the priority information has not been permitted in the configuration information. On the other hand, when not permitting the transmission of the priority information, the controller 230 may include the information indicating that the transmission of the priority information has not been permitted in the configuration information.

For example, in a case where the path information is available in the UE 100, the controller 120 of the UE 100 may execute control of the following processing. Therefore, the controller 120 may execute the path report procedure when the path information is available in the UE 100.

### Step S102

The transmitter 111 of the UE 100 transmits a message including the availability information indicating that the path information is available to the base station 200. The receiver 212 of the base station 200 receives the message including the availability information from the UE 100. The message is, for example, an RRC reestablishment complete (RRC ReestablishmentComplete) message. In addition to the RRC reestablishment complete message, the message used to transmit the availability information may be, for example, at least one of an RRC setup complete (RRC SetupComplete) message, an RRC connection reestablishment complete (RRC ConnectionReestablishmentComplete) message, an RRC reconfiguration complete (RRCReconfigurationComplete) message, an RRC resume complete (RRCResumeComplete) message, and a UE assistance information (UE Assistance Information) message.

The controller 120 of the UE 100 may determine whether or not the transmission of the priority information has been permitted. For example, the controller 120 may make a determination based on the configuration information. For example, when transmission permission/non-permission information indicating that the transmission of the priority information has been permitted is included in the configuration information, the controller 120 may determine that the transmission of the priority information has been permitted. When transmission permission/non-permission information indicating that the transmission of the priority information has not been permitted is included in the configuration information, the controller 120 may determine that the transmission of the priority information has not been permitted. For example, when transmission permission/non-permission information indicating that the transmission of the priority information has been permitted is included in the configuration information, the controller 120 may determine that the transmission of the priority information has been permitted. When transmission permission/non-permission information indicating that the transmission of the priority information has not been permitted is included in the configuration information, the controller 120 may determine that the transmission of the priority information has not been permitted.

Alternatively, the controller 120 may determine that the transmission of the priority information has been permitted when the configuration information includes information indicating that the transmission of the priority information has been permitted. On the other hand, when the configuration information does not include the information regarding the permission to transmit the priority information, the controller 120 may determine that the transmission of the priority information has not been permitted.

Alternatively, the controller 120 may determine that the transmission of the priority information has been permitted when the configuration information does not include information indicating that the transmission of the priority information has not been permitted. On the other hand, when the configuration information includes information indicating that the transmission of the priority information has not been permitted, the controller 120 may determine that the transmission of the priority information has not been permitted.

When the transmission of the priority information has been permitted, the controller 120 may include the priority information in the message including the availability information. As a result, the transmitter 111 can transmit the priority information when transmitting the availability information to the base station 200. Further, the transmitter 111 can transmit the priority information to the base station 200 when the transmission of the priority information has been permitted from the base station 200. The receiver 212 of the base station 200 receives the priority information from the UE 100. On the other hand, when the transmission of the priority information has not been permitted, the controller 120 may not include the priority information in the message including the availability information.

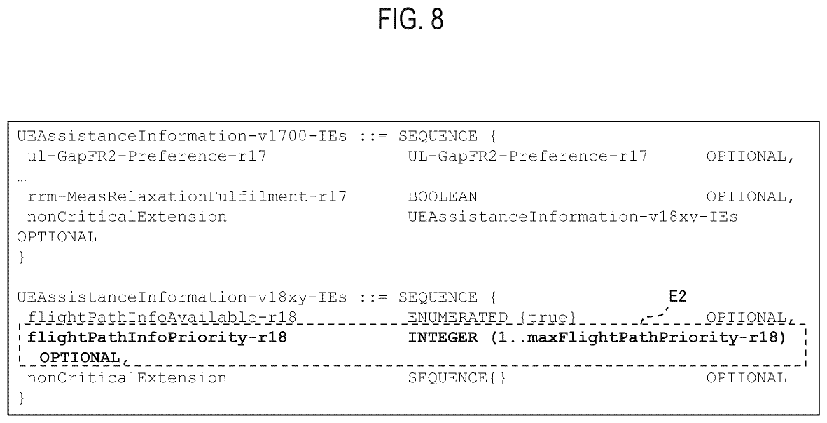

As illustrated in E2 of FIG. 8, the controller 120 may set the availability information (for example, flightPathInfoAvailable) and the priority information (for example, flightPathInfoPriority) in each field in parallel.

The priority information is information regarding a priority of the path. The priority information may indicate, for example, a priority configured for the entire path. That is, the priority may be a priority of the entire path. The priority information may indicate a degree of emergency.

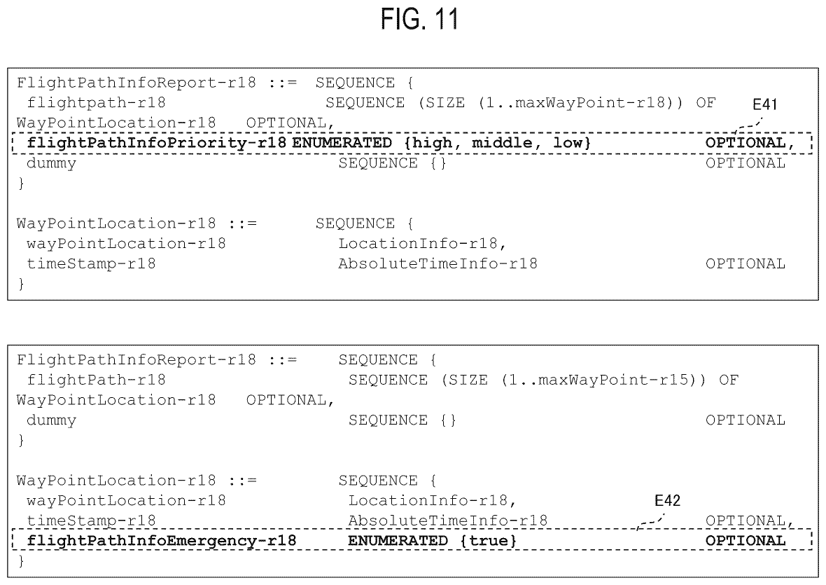

As illustrated in E2 of FIG. 8, the priority information may be an integer value (for example, 1.. maxFlightPathPriority-r18) indicating a priority. For example, the priority information may be indicated by any priority of high (high), middle (middle), and low (low) (see E41 in FIG. 11). The priority information may be indicated by any priority of emergency (emergency) and normal (normal) (refer to E42 in FIG. 11), for example. Therefore, the priority information may be information indicated by an enumerated (enumerated) value.

The priority information may be, for example, information (true/false) indicating whether or not the priority is a high priority (high priority). The priority information may be, for example, information (true/false) indicating whether or not it is emergency (emergency). Therefore, the priority information may be information indicated by a true/false value (for example, enumerated or boolean).

Furthermore, the controller 120 may determine whether or not transmission of the availability information has been permitted. For example, the controller 120 may make determination based on the above-described configuration information (for example, the configuration information regarding the transmission of the priority information). The controller 120 may determine (or regard) that the transmission of the availability information has been permitted when the transmission of the priority information has been permitted based on the configuration information. In a case where the transmission of the priority information has not been permitted, the controller 120 may determine (or regard) that the transmission of the availability information has not been permitted.

The controller 120 may regard that the transmission of the availability information based on the message transmitted with the UE 100 as the origin such as the UE assistance information message used for the indication of the UE assistance information to the network has been permitted based on the configuration information. Therefore, when the transmission of the availability information has not been permitted, the controller 120 may regard that the transmission of the availability information based on the message transmitted with the UE 100 as the origin has not been permitted. In this case, even in a case where the transmission of the availability information has not been permitted, the controller 120 may be able to transmit the availability information by using a message (for example, an RRC reconfiguration complete message, an RRC setup complete message, an RRC reestablishment complete message, and an RRC resume complete message) transmitted as a response to the RRC message (for example, an RRC reconfiguration message, an RRC setup message, an RRC reestablishment message, and an RRC resume message) from the base station 200. Alternatively, in a case where the transmission of the availability information has not been permitted, the controller 120 may regard that the transmission of the availability information has been prohibited regardless of which message is used.

When receiving the availability information, the controller 230 of the base station 200 may perform control to execute the processing of step S103. Furthermore, in a case where the priority information is received, the controller 230 may determine whether or not to execute the processing of step S103 (that is, the request for reporting the path information) based on the priority information. For example, the controller 230 may determine that the report of the path information is requested in at least one of (a) a case where the priority is higher than the threshold and (b) a case where the priority indicates emergency. In a case where the priority is the threshold or less, the controller 230 may determine that the report of the path information is not requested until a predetermined condition is satisfied. The predetermined condition is, for example, at least one of (a) a number of UEs 100 to be subjected to communication control based on the path information is a certain number or less, (b) a number of other UEs having a higher priority level of the path than the priority level of the path of the UE 100 is a certain number or less, and (c) a processing load of the base station 200 is a certain value or less.

In a case where it is determined that the report of the path information is to be requested, the controller 120 may perform control to execute the processing of step S103.

### Step S103

The transmitter 211 of the base station 200 transmits a request message requesting report of the path information to the UE 100. The receiver 112 of the UE 100 receives the request message from the base station 200. Specifically, the transmitter 111 of the base station 200 transmits, to the UE 100, a UE information request (UEInformationRequest) message including configuration information for requesting report of path information. The receiver 112 of the UE 100 receives the UE information request message including the configuration information from the base station 200. The message may be a message requesting the path information and/or the report of the path information. Note that the UE information request message is a message used by the network 10 to retrieve information from the UE 100.

The configuration information may be information (for example, FlightPathInfoReportConfig) for specifying (specify) the configuration of the report of the path information. Note that the configuration information may include, for example, information (for example, maxWayPointNumber) indicating a maximum number of points on a path (for example, waypoints) that can be included in the report of the path information when the UE 100 can use the path information. The configuration information may include information (for example, includeTimeStamp) indicating whether or not a timestamp of each point can be reported in the report of the path information when the UE 100 can use timestamp information. The UE 100 may be configured to report a timestamp by the information. The configuration information may include information for requesting (instructing) a report of a timestamp. The controller 120 of the UE 100 may perform control to execute the processing of step S104 based on the configuration information.

Note that the configuration information for requesting the report of the path information may include the above-described predetermined configuration information regarding update control for notifying the base station 200 of the path information update.

### Step S104

The transmitter 111 of the UE 100 transmits the path information to the base station 200 by a response message to the request message. Specifically, the transmitter 111 transmits a UE information response message including path information regarding a planned path of the UE 100 to the base station 200. As a result, the transmitter 111 transmits the path information to the UE 100. The receiver 212 of the base station 200 receives the UE information response message including the path information from the UE 100. Note that the UE information response message is a message used to transfer (transfer) information requested by the network 10.

The path information may include, for example, information regarding a planned path of the UE 100. The path information may indicate, for example, a planned flight path as the planned path of the UE 100. The path information may be referred to as, for example, “flightPathInfoReport”, “flightPath”, or the like. In addition, the path information may indicate a planned traveling path in a case where the UE 100 travels on a land path, or may indicate a planned sailing path in a case where the UE 100 sails on a sea path.

The path information may include location information including location coordinates (for example, location coordinates) of the UE 100. The location coordinates may represent a planned point (location). The location information may be waypoint location information (for example, wayPointLocation) including UE location coordinates for Aerial UE operations. The waypoint location information may be an information element (LocationInfo) used to transfer detailed location information available in the UE 100 in order to correlate a measurement value with UE position information. The location information may be configured by a plurality of pieces of (a list of) waypoint location information. The waypoint may represent planned locations for the UE.

The location coordinates may correspond to each point on the path. Therefore, the planned path may be configured by a plurality of location coordinates. The path information may include information indicating location coordinates indicating a destination. The information indicating the location coordinates indicating the destination may be location coordinates mapped to a specific location (for example, the first or last of (a list of) a plurality of pieces of waypoint location information). Further, the information indicating the location coordinates indicating the destination may be associated with information indicating the destination.

Further, the path information may include timestamp information (for example, timeStamp). The timestamp information may include information indicating a timestamp of a waypoint representing a planned location of the UE. The information may be, for example, information (for example, AbsoluteTimeInfo) indicating an absolute time in a “YY-MM-DD HH:MM:SS” format and using BCD (Binary-coded decimal) encoding.

For example, the controller 120 of the UE 100 may acquire the path information from an air traffic control system. The controller 120 may receive a GNSS (Global Navigation Satellite System) signal and/or a GPS (Global Positioning System) signal for detecting a location, a speed, an altitude, and the like to acquire (generate) the path information. The controller 120 may detect the location, the speed, the altitude, and the like by a sensor included in the UE 100 to acquire (generate) the path information.

Note that the path information may include information indicating an altitude of the UE 100 and/or information indicating a speed of the UE 100. Note that the UE 100 may include a sensor for detecting the altitude and/or the speed of the UE 100.

The receiver 212 of the base station 200 receives the path information from the UE 100. The controller 230 of the base station 200 can execute communication control (for example, handover control, beamforming control, and the like) with the UE 100 based on the received path information. The controller 230 of the base station 200 may execute communication control with the UE 100 based on priority information. That is, the controller 230 may execute the communication control preferentially on the UE 100 moving on a path with a high priority indicated by the priority information over other UEs.

As described above, the controller 120 executes a path report procedure for reporting the path information regarding the planned path of the UE 100 to the base station 200. The transmitter 111 transmits priority information regarding a priority of the path to the base station 200 in the path report procedure. The receiver 212 of the base station 200 receives the priority information regarding the priority of the path from the UE 100 in the path report procedure. As a result, the base station 200 can grasp the priority of the path. The base station 200 can easily execute the communication control based on the path information on a UE 100 having a high priority of the path, that is, a UE 100 for which the communication control based on the path information is desired. As a result, the UE 100 can arrive at the destination in a favorable communication environment. Furthermore, for example, in a case where it is desired to preferentially secure a favorable communication environment such as when a flying UE 100 performs emergency landing due to a failure of equipment or a sudden illness of an occupant, the network 10 can preferentially perform communication control such as beam control based on the priority information. As a result, it is possible to contribute to securing a favorable communication environment in an emergency.

Further, the transmitter 111 may transmit the priority information when transmitting the availability information indicating that the path information is available to the base station 200. As a result, the base station 200 can grasp the priority of the path before requesting the path information. As a result, the base station 200 can preferentially request the path information from the UE 100 with a high priority.

Further, the priority information may indicate a priority configured for the entire path. As a result, the information amount of the priority information can be reduced and the communication resources can be saved as compared with the case where the priority information indicates a priority configured for each point on the path.

Further, the transmitter 111 may transmit the priority information to the base station 200 when the transmission of the priority information has been permitted from the base station 200. As a result, the base station 200 does not need to receive the priority information by using radio resources unnecessarily when not considering the priority information. Alternatively, since the base station 200 that does not support the priority information does not need to receive the priority information, it is possible to suppress an occurrence of a problem based on the priority information.

Further, the receiver 112 may receive a message including configuration information regarding permission of transmission of the priority information from the base station 200. The controller 120 determines whether or not the transmission of the priority information has been permitted based on the configuration information. As a result, the base station 200 can control the transmission of the priority information of the UE 100.

Further, the receiver 112 may receive a message including configuration information regarding permission of transmission of the priority information from the base station 200. The controller 120 may regard that transmission of the availability information indicating that the path information is available has been permitted based on the configuration information. As a result, the network 10 can control the transmission of the availability information of the UE 100, and can permit the transmission of the availability information as necessary.

### Second Operation Example

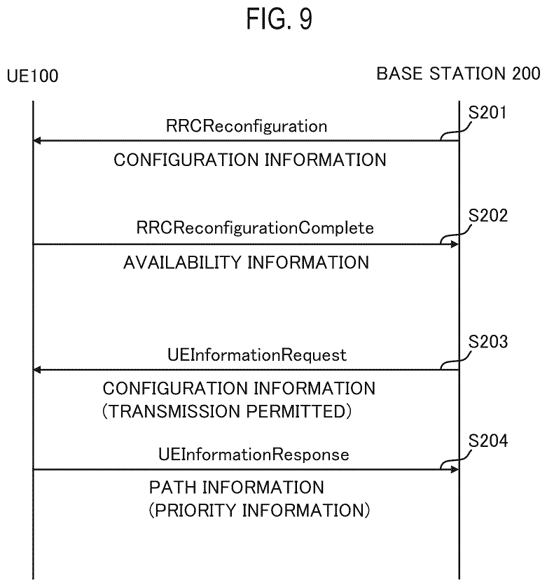

A second operation example of the mobile communication system 1 will be described with reference to FIGS. 9 to 11. The description of parts similar to those in the above-described operation example will be omitted. In the present operation example, the UE 100 transmits the priority information together with the path information.

### Steps S201 and S202

These steps are similar to steps S101 and S102. In step S202, the UE 100 may not transmit the priority information.

Note that as in step S102, the controller 120 may determine whether or not transmission of the availability information has been permitted based on the configuration information. For example, the controller 120 may transmit the availability information in a case where transmission of the availability information has been permitted. On the other hand, when the transmission of the availability information has not been permitted, the controller 120 may perform control not to include the transmission of the availability information in the message.

### Step S203

As in step S103, the transmitter 211 of the base station 200 transmits a UE information request message including configuration information for requesting report of path information to the UE 100. The receiver 112 of the UE 100 receives the UE information request message including the configuration information.

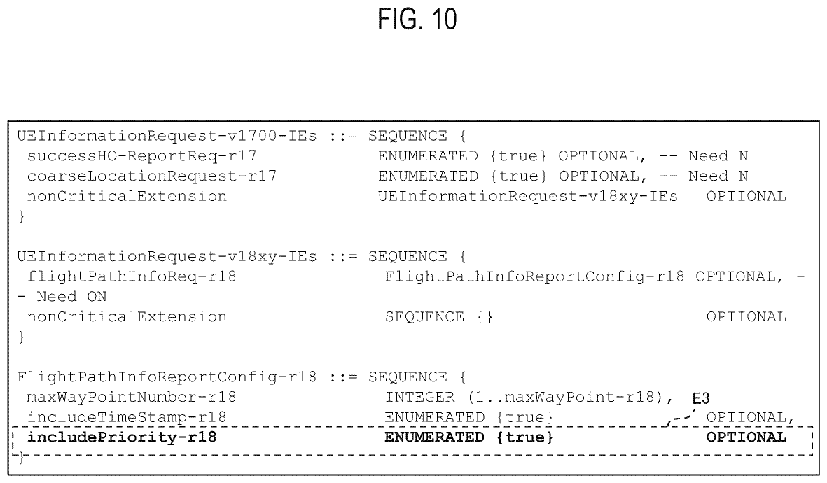

The controller 230 of the base station 200 may execute processing similar to that in step S101 regarding permission of transmission of the priority information. For example, as illustrated in E3 of FIG. 10, the controller 230 may include transmission permission/non-permission information (for example, includePriority) in the configuration information (for example, flightPathInfoReq, FlightPathInfoReportConfig). When permitting the transmission of the priority information, the controller 230 may set information indicating that the transmission of the priority information has been permitted (for example, “true” in E12 of FIG. 7) in a predetermined field in which transmission permission/non-permission information can be set. On the other hand, when not permitting the transmission of the priority information, the controller 230 may set an empty value (or a null value) in the predetermined field. Alternatively, the controller 230 may not include the predetermined field in the configuration information.

The transmission permission/non-permission information may be information for specifying a type of the priority information. The information may be, for example, priority information indicating a priority configured for the entire path, or may indicate any of priority information indicating a priority configured for each point on the path and priority information indicating both priorities. The information specifying the type of the priority information to be transmitted may be included in the configuration information separately from the transmission permission/non-permission information.

### Step S204

As in step S104, the transmitter 111 of the UE 100 transmits the UE information response message including the path information to the base station 200. The transmitter 111 transmits the priority information when transmitting the path information to the base station 200 by the response message to the request message. The receiver 112 of the base station 200 receives the priority information from the UE 100.

The priority information may indicate a priority configured for the entire path. For example, as illustrated in E41 of FIG. 11, the controller 120 may include a plurality of pieces of location information (for example, WayPointLocation) and priority information (for example, flightPathInfoPriority) in the path information (for example, FlightPathInfoReport).

The priority information may indicate a priority configured for each point on the path. For example, as illustrated in E42 of FIG. 11, the controller 120 may include priority information (for example, flightPathInfoPriority) associated with each of a plurality of pieces of location information (for example, WayPointLocation) indicating each point on the path in the path information (for example, FlightPathInfoReport). The controller 120 may include, in each piece of location information (wayPointLocation or LocationInfo), priority information (for example, flightPathInfoPriority) indicating a priority of the point indicated by the location information.

The controller 120 may include both the priority information indicating the priority configured for the entire path and the priority information indicating the priority configured for each point on the path in the path information. In a case where the request message includes information for specifying the type of the priority information, the controller 120 may determine the type of the priority information to be included in the response message (path information) based on the information.

Similarly to step S102, the controller 120 may determine whether or not the transmission of the priority information has been permitted. When the transmission of the priority information has been permitted from the base station 200, the controller 120 may include the priority information in the response message. As a result, the transmitter 111 can transmit the priority information to the base station 200 when the transmission of the priority information has been permitted from the base station 200. On the other hand, when the transmission of the priority information has not been permitted from the base station 200, the priority information may not be included in the response message.

The receiver 212 of the base station 200 receives the UE information request message including the path information and the priority information. The controller 230 of the base station 200 may execute the same operation as step S406. In a case where the priority information indicates the priority configured for each point on the path, the controller 230 may execute communication control preferentially on a UE 100 moving to a point with a high priority and/or a UE 100 moving between points with a high priority than other UEs.

As described above, the receiver 112 may receive the request message requesting report of the path information from the base station 200. The transmitter 111 may transmit the priority information when transmitting the path information to the base station 200 by the response message to the request message. As a result, since the priority information can be transmitted when the UE 100 actually transmits the path information, it is possible to suppress the transmission of the priority information even though the base station 200 does not request the path information. As a result, radio resources can be effectively utilized.

Further, the priority information may indicate the priority configured for each point on the path. As a result, the UE 100 can communicate the priority of at least a part of the path to the network 10. As a result, the network 10 (base station 200) executes the communication control based on the path information in a part of the path with a high priority instead of the entire path, so that the communication control can be preferentially executed on the UE 100 moving on (a part of) the path with a higher priority. The network 10 can operate flexible communication control.

### Other Embodiments

In the above embodiment, the base station 200 transmits the transmission permission/non-permission information to the UE 100 by using the message individually transmitted to the UE 100, but the present disclosure is not limited thereto. For example, the base station 200 may broadcast the transmission permission/non-permission information by using, for example, system information block (SIB) information.

In the above-described embodiment, the mobile communication system 1 has been described by taking a mobile communication system based on NR as an example. However, the mobile communication system 1 is not limited to this example. The mobile communication system 1 may be a system conforming to a TS of any of LTE (Long Term Evolution) or another generation system (for example, a sixth generation) of the 3GPP standard. The base station 200 may be an eNB that provides E-UTRA user plane and control plane protocol termination toward the UE 100 in LTE. The mobile communication system 1 may be a system conforming to a TS of a standard other than the 3GPP standard. The base station 200 may be an IAB (Integrated Access and Backhaul) donor or an IAB node.

In the above-described embodiment, the mobile communication system 1 has been described by taking a mobile communication system based on NR as an example. However, the mobile communication system 1 is not limited to this example. The mobile communication system 1 may be a system conforming to a TS of any of LTE or another generation system (for example, a sixth generation) of the 3GPP standard. The base station 200 may be an eNB that provides E-UTRA user plane and control plane protocol termination toward the UE 100 in LTE. The mobile communication system 1 may be a system conforming to a TS of a standard other than the 3GPP standard.

The steps in the operations of the above-described embodiments are not necessarily executed in chronological order according to the order described in the flowcharts or the sequence diagrams. For example, the steps in the operations may be executed in an order different from the order described as the flowcharts or the sequence diagrams, or may be executed in parallel. Further, a part of the steps in the operations may be deleted, or an additional step may be added to the processing. Furthermore, each operation flow described above is not limited to be implemented separately and independently, and two or more operation flows can be implemented in combination. For example, a part of steps of one operation flow may be added to another operation flow, or a part of steps of one operation flow may be replaced with a part of steps of another operation flow.

A program for causing a computer to execute each process performed by the UE 100 or the base station 200 may be provided. The program may be recorded in a computer-readable medium. The program can be installed in a computer by using the computer-readable medium. Here, the computer-readable medium in which the program is recorded may be a non-transitory recording medium. The non-transitory recording medium is not particularly limited, and may be, for example, a recording medium such as a CD-ROM (Compact Disc Read Only Memory) or a DVD-ROM (Digital Versatile Disc Read Only Memory). Further, a circuit that executes each process performed by the UE 100 or the base station 200 may be integrated, and at least a part of the UE 100 or the base station 200 may be configured as a semiconductor integrated circuit (a chipset, or a SoC (System On Chip)).

In the above-described embodiment, “transmit” may mean performing processing of at least one layer in a protocol stack used for transmission, or may mean physically transmitting a signal by radio or wire. Alternatively, “transmit” may mean a combination of performing the processing of the at least one layer and physically transmitting the signal by radio or wire. Similarly, “receive” may mean performing processing of at least one layer in a protocol stack used for reception, or may mean physically receiving a signal by radio or wire. Alternatively, “receive” may mean a combination of performing the processing of the at least one layer and physically receiving the signal by radio or wire. Similarly, “obtain/acquire” may mean acquiring information from stored information, may mean acquiring information from information received from another node, or may mean acquiring the information by generating the information. Similarly, descriptions of “based on” and “depending on/in response to” do not mean “based only on” and “depending only on/in response only to” unless otherwise specified. The description of “based on” means both “based only on” and “at least partially based on”. Similarly, the description of “in response to” means both “in response only to” and “at least partially in response to”. Similarly, “include” and “comprise” do not mean including only enumerated items, and may include only the enumerated items, or may mean including further items in addition to the enumerated items. Similarly, in the present disclosure, “or” does not mean an exclusive logical sum, and means a logical sum. Furthermore, any reference to elements using designations such as “first” and “second” used in the present disclosure does not generally limit the amount or order of those elements. These designations may be used in the present disclosure as a convenient method for distinguishing between two or more elements. Therefore, a reference to a first element and a second element does not mean that only two elements can be adopted there, or that the first element must precede the second element in some way. In the present disclosure, for example, when articles are added by translation, such as a, an, and the in English, these articles shall include a plurality of items unless it is clear from the context that this is not the case.

Although the present disclosure has been described in accordance with the examples, it is understood that the present disclosure is not limited to the examples or the structures. The present disclosure also includes various modifications and variations within the scope of equivalents. In addition, various combinations and forms, and further, other combinations and forms including only one element, more elements, or less elements thereof also fall within the scope and spirit of the present disclosure.

### Supplementary Notes

Features related to the above-described embodiments are additionally described.

### Supplementary Note 1

A communication apparatus, including:
a controller configured to execute a procedure for reporting path information regarding a planned path of the communication apparatus to a base station; and
a transmitter configured to transmit priority information regarding a priority of the path to the base station in the procedure.

### Supplementary Note 2

The communication apparatus according to supplementary note 1, in which
the transmitter transmits the priority information when transmitting availability information indicating that the path information is available to the base station.

### Supplementary Note 3

The communication apparatus according to supplementary note 1 or 2, further including:
a receiver configured to receive a request message requesting report of the path information from the base station, in which
the transmitter transmits the priority information when transmitting the path information to the base station by a response message to the request message.

### Supplementary Note 4

The communication apparatus according to any one of supplementary notes 1 to 3, in which
the priority information indicates a priority configured for an entire path.

### Supplementary Note 5

The communication apparatus according to any one of supplementary notes 1 to 4, in which
the priority information indicates a priority configured for each point on the path.

### Supplementary Note 6

The communication apparatus according to any one of supplementary notes 1 to 5, in which
the transmitter transmits the priority information to the base station when transmission of the priority information has been permitted from the base station.

### Supplementary Note 7

The communication apparatus according to supplementary note 6, further including:
a receiver configured to receive a message including configuration information regarding permission to transmit the priority information, from the base station, in which
the controller determines whether or not transmission of the priority information has been permitted based on the configuration information.

### Supplementary Note 8

The communication apparatus according to any one of supplementary notes 1 to 7, further including:
a receiver (112) configured to receive a message including configuration information regarding permission to transmit the priority information from the base station, in which
the controller regards that transmission of the availability information indicating that the path information is available has been permitted based on the configuration information.

### Supplementary Note 9

A base station, including:
a receiver configured to receive priority information regarding a priority of the path from a communication apparatus in a procedure for reporting path information regarding a planned path of the communication apparatus to the base station.

### Supplementary Note 10

A communication method executed by a communication apparatus, the communication method including:
a step of executing a procedure for reporting path information regarding a planned path of the communication apparatus to a base station, in which
the step includes a step of transmitting priority information regarding a priority of the path to the base station in the procedure.

1. A communication apparatus, comprising:
a controller configured to execute a procedure for reporting path information indicating a path of the communication apparatus to a base station; and
a transmitter configured to transmit information regarding a priority of the path to the base station.

2. The communication apparatus according to claim 1, wherein
the transmitter transmits the information regarding the priority of the path when transmitting availability information indicating that the path information is available to the base station.

3. The communication apparatus according to claim 1, further comprising:
a receiver configured to receive a request message requesting report of the path information from the base station, wherein
the transmitter transmits the information regarding the priority of the path when transmitting the path information to the base station by a response message to the request message.

4. The communication apparatus according to any one of claim 1, wherein
the information regarding the priority of the path indicates a priority configured for an entire path.

5. The communication apparatus according to claim 1, wherein
the information regarding the priority of the path indicates a priority configured for each point on the path.

6. The communication apparatus according to claim 1, wherein
the transmitter transmits the information regarding the priority of the path to the base station when transmission of the information regarding the priority of the path has been permitted from the base station.

7. The communication apparatus according to claim 6, further comprising:
a receiver configured to receive a message including configuration information regarding permission to transmit the information regarding the priority of the path from the base station, wherein
the controller determines whether or not transmission of the information regarding the priority of the path has been permitted based on the configuration information.

8. The communication apparatus according to claim 1, further comprising:
a receiver configured to receive a message including configuration information regarding permission to transmit the information regarding the priority of the path from the base station, wherein
the controller regards that transmission of the availability information indicating that the path information is available has been permitted based on the configuration information.

9. A base station, comprising:
a controller configured to control a procedure for reporting path information indicating a path of a communication apparatus from the communication apparatus to the base station; and
a receiver configured to receive information regarding a priority of a path from a communication apparatus.

10. A communication method executed by a communication apparatus, the communication method comprising the steps of:
executing a procedure for reporting path information indicating a path of the communication apparatus to a base station, and
transmitting information regarding a priority of the path to the base station.
